(19) United States
(12) Patent Application Publication
(10) Pub. No.: US 2022/0101759 A1
(43) Pub. Date: Mar. 31, 2022

(54) TAG FASTENER

(71) Applicant: ZIP BCN SOLUTIONS, S.L., VILADECAVALLS (Barcelona) (ES)

(72) Inventor: Joan MONTLLO RIBO, VILADECAVALLS (Barcelona) (ES)

(73) Assignee: ZIP BCN SOLUTIONS, S.L., VILADECAVALLS (Barcelona) (ES)

(21) Appl. No.: 17/427,637

(22) PCT Filed: Feb. 28, 2019
(86) PCT No.: PCT/ES2019/070123

§ 371 Date: Jul. 31, 2021

(30) Foreign Application Priority Data
Feb. 1, 2019 (ES) U201930164

(51) Int. Cl. G09F 3/14

(52) U.S. Cl. CPC G09F 3/14

(57) ABSTRACT

Comprising a long and flexible body (1), which defines two ends (2,3), having fixing means of the female type (4) and the male type (5), on both ends, characterized in that the long and flexible body (1) is lengthwise twisted on itself and is made of such a material as cellulose (7) or a by-product thereof, and/or the fixing means (4,5) are made of a biodegradable plastic material.

Tag fastener of the type comprising a long and flexible body which defines two ends, having fixing means of the female and male type on both ends, characterized in that the long and flexible body is lengthwise twisted on itself, and is made of a cellulose material or a by-product thereof, and/or the fixing means are made of a biodegradable plastic material.

### BACKGROUND OF THE INVENTION

Known in the state of the art are different devices for hanging labels, in particular, fasteners.

Thus, belonging to the state of the art is British patent GB2143782 “FASTENER AND METHOD OF MAKING THE SAME”, in the name of TOSKA CO LTD, from 1984, referring to a type of attachment comprising a female member having an opening, a male member that can be coupled with the opening of the female member and a cord attaching the female and male members and a set of fasteners comprising a plurality of said fasteners attached to each other. The female and male members are moulded from a thermoplastic synthetic resin and fuse-welded with the cord.

### BRIEF DESCRIPTION OF THE INVENTION

This invention belongs to the field of label or tag fasteners.

The nearest document is British Patent GB2143782.

This patent solves the problem of using long cords (0.5 m a 1 m).

For this purpose, the patent proposes a special over-moulding of the fixing means.

On the other hand, the patent has the disadvantage that it cannot be manufactured with biodegradable materials such as cellulose, and more specifically, paper, because the cords would tear if they were over-moulded according to the method; in addition, the fixing means cannot be recovered for recycling, since they are made of plastic material.

This invention solves the problem of making fasteners of any size using biodegradable materials such as cellulose, which material is regarded as an ecological material that can be easily recycled after use, as a long and flexible body, making the cellulose or its by-product strong enough and not easily ripped. Since the fastener is difficult to remove, the fastener also prevents stealing of, for example, an item of clothing having the fastener and a tag.

This is solved by twisting the cellulose, which provides the strength.

On the other hand, the problem of ecologically reusing the fixing means is also solved, since the attachment is made of a biodegradable plastic material.

An object of the present invention is a tag fastener, of the type comprising a long and flexible body which defines two ends, having fixing means of the female and male type, on both ends, characterized in that the long and flexible body is lengthwise twisted on itself, and is made of a cellulose material or a by-product thereof and/or the fixing means are made of a biodegradable plastic material.

### BRIEF DESCRIPTION OF THE DRAWINGS

To facilitate this description, five sheets with drawings are included that represent one practical embodiment of the invention, which is intended as a non-limiting example of the scope of this invention:

FIG. 1 is a general view of a fastener,

FIG. 2 is a general view of the long and flexible body having a core

FIG. 3 is a view of the long and flexible body having a constriction zone,

FIG. 4 is a view of the long and flexible body having an abrasion zone, and

FIG. 5 is a view of a sectioned female means of attachment and a sectioned male means of attachment.

### PRACTICAL EMBODIMENT OF THIS INVENTION

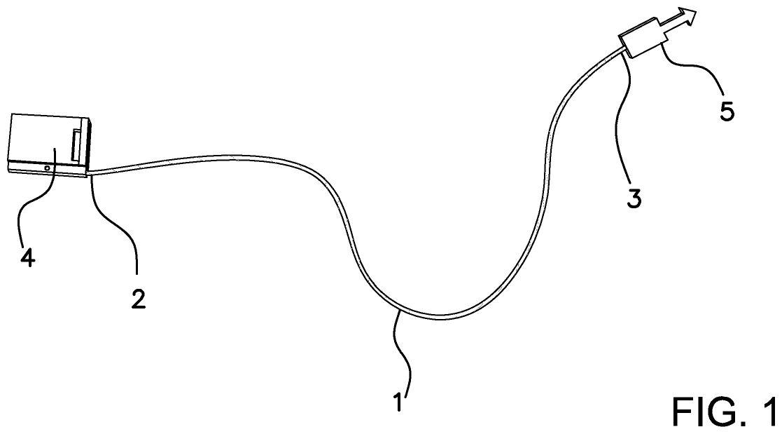

FIG. 1 illustrates a long and flexible body 1 with ends 2,3, and fixing means 4, 5.

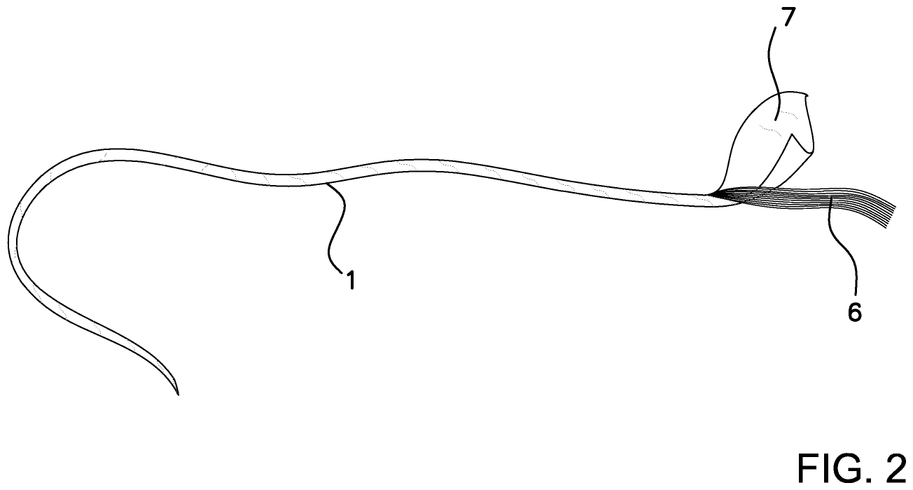

FIG. 2 shows the long and flexible body 1, with its core 6 and cellulose 7.

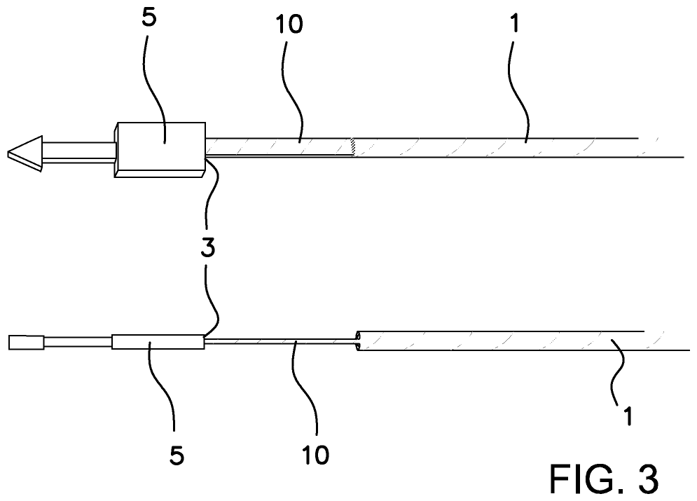

FIG. 3 shows the long and flexible body 1 having a debilitated zone 10 due to constriction 10, end 3, and male fixing 5.

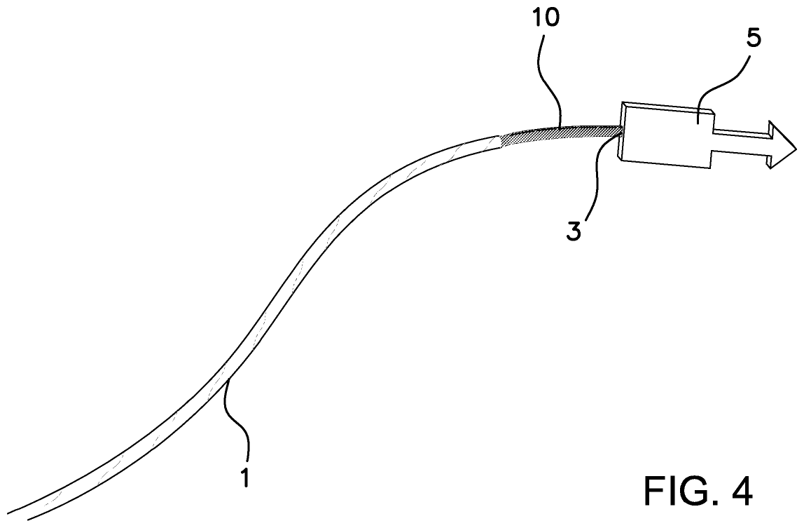

FIG. 4 shows the long and flexible body 1 having a debilitated zone 10 due to constriction and abrasion, end 3, and male fixing 5.

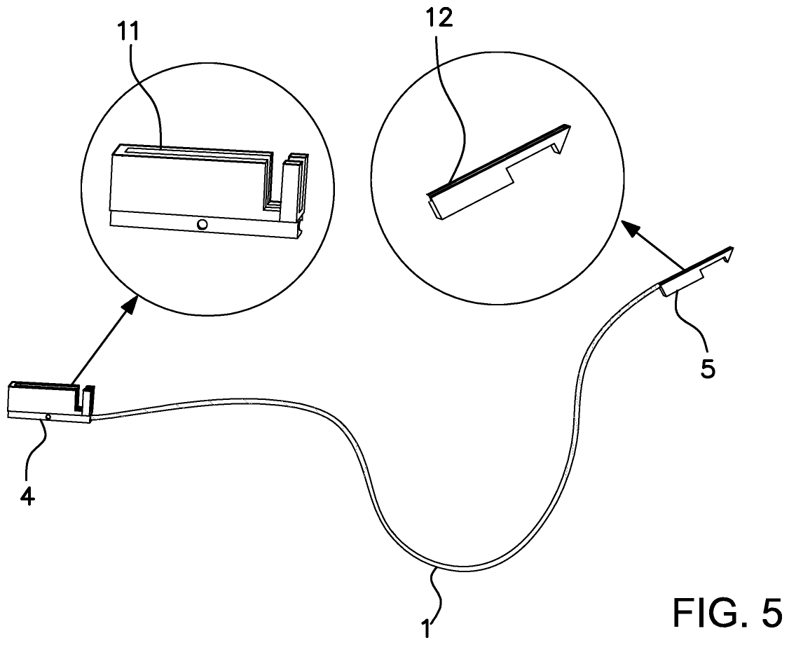

FIG. 5 illustrates the long and flexible body 1, female fixing 4 with its walls 11, and male fixing 5 with its walls 12.

The tag fastener of the present invention comprises a long and flexible body 1, which defines two ends 2,3, having fixing means 4, 5 on both ends. In this way, when the user wishes to close the fastener, the male fixing 5, referred as “arrow”, is moved towards the female fixing 4, referred as “head”, thus closing the fastener.

The long and flexible body 1 is lengthwise twisted on itself and is made of such a material as cellulose 7 or a by-product thereof, for example, paper.

Such twisting allows conferring the long and flexible body 1 a strong but flexible structure, thus preventing the body from easily tearing and, at the same time, being adaptable to the configuration of the object for which it is meant, for example, a garment.

Optionally, the invention has been configured in such a way so that at least one part of the long and flexible body 1 comprises a debilitated area 10. The debilitated area 10 allows the user to easily rip off the fastener and remove it from the garment, for example, and at the same time, if the fastener is broken, it cannot be re-used, a characteristic especially thought in connection to thefts.

The debilitated zone 10 could be obtained by constriction, that is, pressing the long and flexible body 1 until squashed, or by abrasion, that is, using the heat produced by the mould that moulds the ends 2, 3, or by a combination of both, i.e, by constriction and using the abrasion caused by the heat.

One of the manufacturing options is having the debilitated zone 10 located on at least one end 2 or 3, since the mould for making ends 2,3 could be used to configure the debilitated zone 10, using the heat to attain abrasion and profiting from the moment when the mould is closed to squeeze and squash the long and flexible body 1.

Optionally, in order to provide greater strength to the long and flexible body 1, a core 6 of compostable fibre will have been placed inside of the same, being wrapped by cellulose 7 or a by-product of said cellulose.

There is also a possibility that the compostable fibre be of a natural type, facilitating recycling of the same.

Said natural compostable fibre could be viscose.

The fixing means 4, 5 are made of a biodegradable plastic material. In this way, ecological recovery for recycling of the fixing means 4,5 can be achieved.

If a higher ecological performance is desired, the inventor has concluded that for the plastic to be biodegradable and compostable, the walls 11,12 should not be more than 2 mm thick (FIG. 5). This is so because the inventor found that such thickness is the maximum for plastics to comply with the double condition of being biodegradable and compostable and at the same time capable of serving as fixing means 4, 5 for fasteners; that is, being solid enough and performing their task as fixing means and at the same time, being capable of being recovered for the environment. In excess of this 2 mm-thickness, plastics performance diminishes considerably.

An example of a plastic biodegradable and compostable material that can be used is polylactic acid.

The present invention describes a novel tag fastener. The examples provided herein shall not limit the present invention, which may have different applications and/or adaptations, all of which within the scope of the following claims.

1. Tag fastener, comprising:
a long and flexible body having first and second ends, a female type fixing means disposed at the first end and a male type fixing means disposed at the second end,
wherein the long flexible body is lengthwise twisted on itself and is made of a cellulose material or a by-product thereof and
wherein the female and male fixing means are made of a biodegradable plastic material.

2. The tag fastener according to claim 1, wherein at least one part of the long and flexible body includes a debilitated zone.

3. The tag fastener according to claim 2, wherein the debilitated zone is debilitated by constriction or by abrasion.

4. The tag fastener according to claim 3, wherein the debilitated zone is located at least on one of the first and second ends.

5. The tag fastener according to claim 1, wherein the long and flexible body further comprises:
a core made of compostable fibre wrapped by the cellulose or by a by-product of the cellulose.

6. The tag fastener according to claim 5, wherein the compostable fibre is of natural type.

7. The tag fastener according to claim 6, wherein the compostable natural fibre is viscose.

8. The tag fastener according to claim 5, wherein the long and flexible body is made of paper.

9. The tag fastener according to claim 1, wherein the male type and female type fixing means are made of a biodegradable and compostable plastic material having walls having a maximum thickness of 2 mm.

10. The tag fastener according to claim 9, wherein the biodegradable and compostable plastic material is a polylactic acid.

11. The tag fastener according to claim 7, wherein the long and flexible body is made of paper.
